(19) United States
(12) Patent Application Publication
(10) Pub. No.: US 2006/0022492 A1
(43) Pub. Date: Feb. 2, 2006

(54) Modular sliding rigid panel roof system

(75) Inventors: Robert E. Fallis III, Rochester, MI (US); Michael T. Willard, Harrison Township, MI (US); Robert D. Wiechowski, Warren, MI (US)

Correspondence Address: BROOKS KUSHMAN P.C., 1000 TOWN CENTER, TWENTY-SECOND FLOOR, SOUTHFIELD, MI, 48075, US

(73) Assignee: CTS Fahrzeug Dachsysteme GmbH, Rochester Hills, MI (US)

(21) Appl. No.: 11/191,680

(22) Filed: Jul. 28, 2005

Related U.S. Application Data
(60) Provisional application No. 60/591,902, filed on Jul. 28, 2004.

(51) Int. Cl. B60J 7/00

(52) U.S. Cl. 296/216.01

(57) ABSTRACT

A retractable roof assembly for a vehicle is provided that includes relatively movable rigid panels that are positioned to cover a passenger/cargo compartment of the vehicle in an extended position and that are stacked one above another in a retracted position. A telescoping track is provided on opposite lateral sides of the vehicle to guide movement of the roof panels. D-pillars of the roof assembly are slidable between a position wherein they are spaced from the C-pillars to a retracted position in which the D-pillars are adjacent to the C-pillars. Side windows of the vehicle are retracted into the rear quarter panel area of the vehicle.

### CROSS-REFERENCE TO RELATED APPLICATIONS

This application claims the benefit of U.S. provisional application Ser. No. 60/591,902 filed Jul. 28, 2004.

### BACKGROUND OF THE INVENTION

1. Field of the Invention

The present invention relates to a partially retractable roof for a vehicle.

2. Background Art

Retractable roofs and convertible tops are generally designed for sedan or coupe style vehicles. Sport utility vehicles have been provided with removable rigid roofs and snap-on or detachable soft tops that may be manually removed from rigid supports that surround the passenger compartment of the vehicle. Sport utility vehicles and vans may have sun roofs that provide a small open area but generally fail to provide any openings for the rear portion of the passenger compartment.

Vehicles are generally provided in a particular type of body style but some consumers desire multi-purpose vehicles that can function as a passenger vehicle and also as a cargo-carrying vehicle. Recently, a sport utility vehicle was released having a retractable roof. The roof has panels that are retracted and stacked sequentially as they are shifted from the rear tailgate toward the front of the vehicle. This design provides an open rear portion of the vehicle while the side windows and frame members remain in place. The side portions tend to obstruct access from the sides of the vehicle to the rear cargo area of the vehicle.

There is a need for a vehicle roof system that may be simply constructed to provide either a configuration with a fully covered passenger and cargo compartment or a configuration with an open cargo compartment for hauling large items. An important factor for such a design is to allow unobstructed access to the cargo area from the side of the vehicle, as well as the rear. Another important factor for such a design is that it should be easily converted from one configuration to the other. Another important factor for such a design is that it is modular and flexible. Yet another important factor is that the design provide convenient and efficient storage for modular panels when the cargo compartment is open. This invention is directed to solving these and other problems associated with the prior art.

### SUMMARY OF THE INVENTION

According to one aspect of the present invention, a retractable roof for a vehicle is provided that selectively covers a passenger/cargo compartment of the vehicle. The roof comprises a static roof section, a retractable roof section, and a retractable upper tailgate section. The retractable roof section is moved between an extended position rearward of the static roof section to a retracted position vertically stacked relative to the static roof section. The retractable upper tailgate section is moved between an extended position rearward and below the retractable roof section to a retracted position vertically stacked relative to the static roof section and the retractable roof section.

According to other aspects of the present invention as they relate to the above embodiment of the invention further comprise right and left side tracks that extend fore-and-aft and guide movement of the retractable roof section and the retractable upper tailgate section as they are moved between their respective extended and retracted positions. The right and left side tracks may each have a forward portion that is generally disposed above the static roof section and a rearward portion that is generally disposed above the retractable roof section when the retractable tailgate section is in its extended position. The rearward portion of the tracks are telescopically received by the forward portions of the tracks when the retractable upper tailgate section is in its retracted position.

According to other aspects of the present invention, the roof may further comprise right and left C-pillars and right and left D-pillars that support the roof of the vehicle. The C-pillars extend downwardly from the location where the static roof section and retractable roof section are adjacent to one another when the retractable roof section is in its extended position. The D-pillars extend downwardly from the location where the retractable roof section and the retractable tailgate section are adjacent to one another when the retractable tailgate section is in its extended position. The D-pillars are retracted toward the C-pillars when the upper tailgate section is moved to its retracted position. The D-pillars are extended away from the C-pillars when the upper tailgate section is moved to its extended position.

According to other aspects of the present invention, the right and left rear quarter windows are provided that may be retracted downwardly into a right rear quarter panel and a left rear quarter panel, respectively, when the upper tailgate section is moved to its retracted position. A hinge may be provided between the retractable roof section and the retractable upper tailgate section that permits pivotal movement of the tailgate section when it is in its extended position. A sunroof may also be provided that is moved between a closed position forward of and adjacent to the static roof section and an open position vertically stacked relative to the static roof section.

According to another aspect of the present invention, a retractable roof for a vehicle is provided that comprises a static roof section and a retractable roof section that is moved between an extended position rearward of the static roof section to a retracted position vertically stacked relative to the static roof section. A pair of C-pillars extend below the front end of the retractable roof section when in its extended position. A pair of D-pillars extend below a rear end of the retractable roof section. The D-pillars may be retracted toward the C-pillars when the retractable roof section is moved to its retracted position. The D-pillars are extended away from the C-pillars when the retractable roof section is moved to its extended position.

According to other aspects of the above embodiment of the present invention, a right side track and a left side track are provided that extend in a fore-and-aft direction for guiding movement of the retractable roof section as it is moved between the extended and retracted positions. A pillar guide track may be provided on each of the rear quarter panel window sills that guide movement of the D-pillars. The D-pillars each have a follower that engages the pillar guide tracks. Right and left rear quarter windows are provided that may be retracted downwardly into right and left rear quarter panels, respectively, when the D-pillar is extended and retracted toward the C-pillar.

According to another aspect of the invention, a retractable roof assembly for a vehicle is provided that has at least two lateral pairs of pillars and side windows disposed between a belt line of the vehicle and the roof and between fore-and-aft pillars. The windows are retractable below the belt line of the vehicle. The roof assembly comprises a plurality of relatively movable panels that extend laterally across the vehicle. The panels are movable relative to each other in the fore-and-aft direction. A pillar guide track is disposed on the vehicle at the belt line on each side of the vehicle. A follower is provided on each of the pillars of one of the lateral pairs of pillars. The followers are received by the pillar guide tracks to guide movement of the pair of pillars when the windows are retracted.

According to other aspects of the present invention, one of the relatively movable panels may be assembled to the vehicle in a stationary position with at least one of the other relatively movable panels being a slidable panel that is assembled to a track that permits the slidable panel to move in the fore-and-aft direction. The pillar guide track may be provided above the location where the windows are retracted into the vehicle.

According to still further aspects of the present invention, at least two pairs of pillars of the vehicle previously referred to may comprise a pair of A-pillars, a pair of B-pillars, a pair of C-pillars, and a pair of D-pillars. The pair of D-pillars may be provided with followers and the D-pillars are retracted to a position that is adjacent to the C-pillars. In addition, a retractable upper tailgate section may be provided that is disposed between the D-pillars in an extended position and may be moved to a retracted position in which it is vertically stacked relative to the relatively movable roof panels.

The above and other aspects of the invention will be better understood in view of the attached drawings and following detailed description of the illustrated embodiment of the invention.

### BRIEF DESCRIPTION OF THE DRAWINGS

FIG. 1 is a fragmentary rear-side perspective view of a vehicle having a modular sliding rigid panel roof system.

FIG. 2 is a perspective view of a front portion of the system.

FIG. 3 is a perspective view of a fixed intermediate panel portion of the system.

FIG. 4 is a perspective view of a rear roof portion of the system.

FIG. 5 is a perspective view of a tail gate portion of the system.

### DETAILED DESCRIPTION OF THE PREFERRED EMBODIMENT(S)

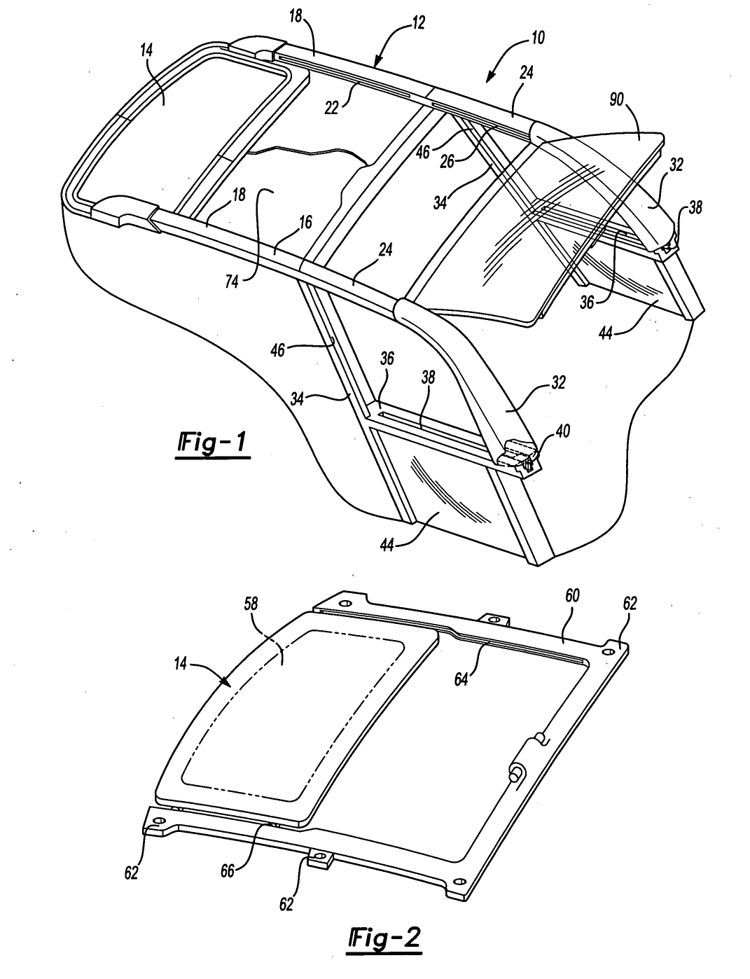

FIG. 1 generally illustrates a vehicle 10 that is provided with a modular sliding panel roof system 12. The vehicle 10 may have a sunroof 14 that may function as a front portion of the system, although the sunroof 14 is not an essential aspect of the invention.

The modular roof system 12 has supporting and guiding members that are generally referred to as a roof guide assembly 16. The roof guide assembly 16 in part comprises a pair of parallel spaced front track members 18 extending along the sides of the vehicle. Each front track member 18 is attached to the vehicle 10 generally above part of the passenger portion of the vehicle 10. Each front track member 18 includes a pair of channels 22 formed on an interior side face. The channels 22 extend longitudinally relative to the vehicle 10 and are vertically spaced with respect to one another. The roof guide assembly 16 further comprises a pair of parallel-spaced rear track members 24. Each rear track member 24 extends longitudinally relative to the vehicle and is disposed rearward of one of the front track members 18. The rear track members 24 are disposed generally above the cargo portion of the vehicle 10. Each rear track member 24 includes a pair of channels 26 formed on the interior side face and extends longitudinally relative to the vehicle 10. The channels 22 and 26 are vertically spaced with respect to one another and extend along the front track members 18 and the rear track members 24, respectively.

The rear track members 24 are assembled to the vehicle 80 to slide relative to the front track members 18. The rear track member 24 of the roof guide assembly 16 is adapted to move between an extended position and a retracted position. In one embodiment, an extensible slide track, not shown, may connect rear track members 24 to front track members 18. In another embodiment, rear track members may slide within front track members in telescoping relationship.

D-pillars 32 are attached to the rear end of the roof guide assembly 16. D-pillars 32 may have an arcuate shape that extends generally downwardly from the roof guide assembly 16. C-pillars 34 extend generally downwardly from the interface between a front track member 18 and a rear track member 24. Window sill 36 extends horizontally between the base of a D-pillar 32 and a C-pillar 34 on each side of the vehicle 10. Guide track 38 is formed in the window sill 36. Each D-pillar 32 includes a track follower 40 extending from the base. The track follower 40 engages the guide track 38 to allow the D-pillar to move relative to the guide track 38.

The vehicle further includes rear side windows 44 that can be opened and closed. C- and D-pillars include window tracks 46 that oppose one another. Window tracks 46 engage the side edges of the windows 44. Window tracks 46 extend vertically from the top of each pillar and below the window sill 36. Windows 44 retract downward below the window sill 36 into the vehicle side body in a fully opened position. Windows 44 may be operated manually or automatically, as is well known in the art.

Referring to FIG. 2, a sunroof 14 includes a movable panel 58, and a sunroof frame 60. Frame 60 is attached to the vehicle 10 at various attachment points 62. Frame 60 includes opposed guide tracks 64 that are integrally formed in the frame 60 and face each other in an opposed relationship. Guide tracks 64 extend parallel with the vehicle sides. Movable panel 58 includes track followers 66. Guide tracks 64 are adapted to receive track followers 66. Fixed panel 74 is permanently affixed to frame 60. Locating members 76 correspond with apertures (not shown) formed in the frame 60.

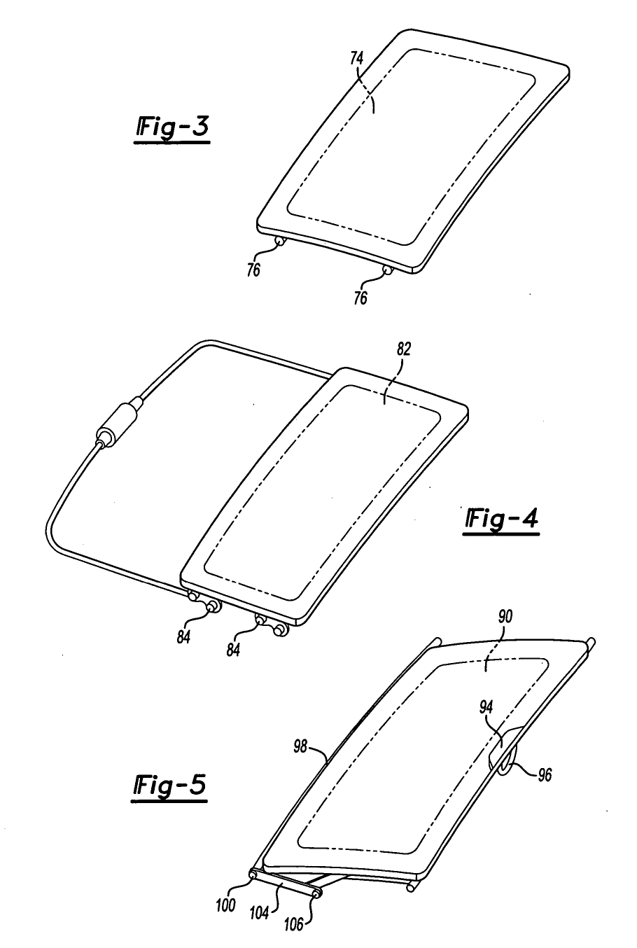

Referring to FIGS. 2 and 3, when the movable panel 58 is in the closed position, the movable panel 58 and the fixed panel 74 are generally coplanar. Fixed panel 74 may include locating members 76 that extend from the bottom surface of the fixed panel 74. When the movable 58 panel is in an open position, the movable panel is disposed below the fixed panel 74 in a stacked relationship. The movable panel 58 may comprise glass or may comprise any other opaque, transparent, or translucent material that is suitable for automotive vehicle exterior applications. The fixed panel 74 may comprise glass or metal and may be decorated to match or to accent the vehicle exterior.

FIGS. 1 and 4 illustrates a stackable panel 82 that may be generally rectangular, as illustrated. A set of track followers 84 project from opposing edges of the panel 82. Track followers 84 engage channels 22 and 26 in the roof guide assembly 16. Panel 82 is movable within the channels 22 and 26 between an extended position and a retracted position. Panel 82 is located generally rearward of the C-pillars 34 in the extended position. Panel 82 is located generally forward of the C-pillars 34 in a retracted position. Panel 82 functions as a roof panel when it is in the extended position. Panel 82 forms a seal with mating components that is impermeable to air, water, and other deleterious elements. Panel 82 may comprise glass, metal, or any other opaque, transparent, or translucent material that is suitable for automotive vehicle exterior applications.

FIGS. 1 and 5 illustrate a stackable rear window 90. Rear window 90 includes a handle 94 and a latch mechanism 96. Rear window 90 further includes a hinge 98 disposed on an edge of the rear window 90. Hinge 98 includes a pair of guide pins 100 that extend transversely from either end. Guide pins 100 engage the channels 26 of the rear track members 18 of the roof guide assembly 16 to allow the rear window 90 to pivot and slide relative to the roof guide assembly 16. The rear window 90 further includes a linkage mechanism 104 that is attached to the hinge 98. The linkage mechanism 104 includes track pins 106 that extend outwardly in a transverse direction from linkage mechanism 104. Track pins 106 slidably engage channels 26 formed on opposing faces of the rear track members 24.

The rear window 90 is movable between an extended position and a retracted position. In the extended position, the rear window 90 is located substantially rearward of the roof rack 16 and spans the opening between the D-pillars 32. Guide pins 100 pivotally engage the channels 26 in the rear track members 26 of the roof guide assembly 16. The rear window 90 may be opened and closed. The rear window 90 is generally aligned with D-pillars 32 when closed.

The window 90 pivots upwardly open from the closed position by rotating on the hinge 98. The rear window 90 may move into a retracted position when open. The rear window 90 moves vehicle-forward along the roof guide assembly 16 causing guide pins 100 to move and linkage pins 106 to move through channels 26. In the fully retracted position, the rear window 90 is generally located above the fixed panel 74 and extends between the roof guide assembly 16.

The rear window 90 may be in an extended or retracted position when the roof guide assembly 16 is in an extended position. Similarly, the rear window 90 may be in an extended or retracted position when the roof guide assembly 16 is in a retracted position.

To convert the roof guide assembly 16 from an extended position to a retracted position, the process may begin with side windows 44 retracting into the side of the vehicle, or rear quarter panel area. Panel 82 then moves through channels 22 and 26 from a closed position to a stacked position. Panel 82 is disposed generally above fixed panel 74 in the stacked position. Next, rear track members 24 move vehicle-forward with the D-pillars 32 following. As D-pillars move forward, track followers 40 slide vehicle-forward along guide tracks 38 until D-pillars 32 contact C-pillars 34.

To convert the roof guide assembly 16 from a retracted position to an extended position, the user may perform the steps outlined above in the reverse order. Alternatively, the steps and the order may be varied to accomplish similar functions.

The steps outlined above may be performed manually by the vehicle user, or may be automated and power-driven. One or more electrical, pneumatic or hydraulic motors or pistons may be operatively connected to move the panel 82, rear window 90, and the rear track members 24 between their extended and retracted positions. Sunroof 14 may be power operated as is well known in the art. Panel 82 and rear window 90 may have a single power operating system that supports both or may have separate power driving mechanisms.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A retractable roof for a vehicle for selectively covering a passenger/cargo compartment of the vehicle, the roof comprising:
a static roof section;
a retractable roof section that is moved between an extended position reward of the static roof section to a retracted position vertically stacked relative to the static roof section; and
a retractable upper tailgate section that is moved between an extended position rearward and below the retractable roof section to a retracted position vertically stacked relative to the static roof section and the retractable roof section.

2. The retractable roof for a vehicle of claim 1 further comprising a right side track and a left side track that extend fore-and-aft and guide movement of the retractable roof section and the retractable upper tailgate section as they are moved between their respective extended and retracted positions.

3. The retractable roof for a vehicle of claim 2 wherein the right and left side tracks each have a forward portion that is generally disposed above the static roof section and a rearward portion that is generally disposed above the retractable roof section when the retractable upper tailgate section is in its extended position and is telescopically received by the forward portion of the side tracks when the retractable upper tailgate section is in its retracted position.

4. The retractable roof for a vehicle of claim 1 further comprising right and left C-pillars and right and left D-pillars that support the roof of the vehicle, the C-pillars extending downwardly from the location where the static roof section and retractable roof section are adjacent to one another when the retractable roof section is in its extended position, the D-pillars extending downwardly from the location where the retractable roof section and the retractable upper tailgate section are adjacent to one another when the retractable upper tailgate section is in its extended position, the D-pillars being retracted towards the C-pillars when the upper tailgate section is moved to its retracted position and being extended away from the C-pillars when the upper tailgate section is moved to its extended position.

5. The retractable roof for a vehicle of claim 1 further comprising right and left rear quarter windows that are retracted downwardly into a right rear quarter panel and a left rear quarter panel, respectively, when the upper tailgate section is moved to its retracted position.

6. The retractable roof for a vehicle of claim 1 further comprising a hinge disposed between the retractable roof section and the retractable upper tailgate section to provide a mechanism for pivotally moving the upper tailgate section when it is in its extended position.

7. The retractable roof for a vehicle of claim 1 further comprising a sunroof that is moved between a closed position forward of and adjacent to the static roof section and an open position vertically stacked relative to the static roof section.

8. A retractable roof for a vehicle comprising:
a static roof section;
a retractable roof section that is moved between an extended position rearward of the static roof section to a retracted position vertically stacked relative to the static roof section; and
a pair of C-pillars extending below the front end of the retractable roof section when in its extended position and a pair of D-pillars extending below a rear end of the retractable roof section, wherein the D-pillars may be retracted towards the C-pillars when the retractable roof section is moved to its retracted position and being extended away from the C-pillars when the retractable roof section is moved to its extended position.

9. The retractable roof for a vehicle of claim 8 further comprising a right side track and a left side track that extend fore-and-aft and guide movement of the retractable roof section as it is moved between the extended and retracted positions.

10. The retractable roof for a vehicle of claim 9 further comprising a pillar guide track provided on each of the rear quarter panel window sills that guide movement of the D-pillars that each have a follower that engages the pillar guide tracks.

11. The retractable roof for a vehicle of claim 9 further comprising right and left rear quarter windows that are retracted downwardly into a right rear quarter panel and a left rear quarter panel, respectively, when the D-pillar is extended and retracted towards the C-pillar.

12. The retractable roof for a vehicle of claim 9 further comprising a sunroof that is moved between a closed position forward of and adjacent to the static roof section and an open position vertically stacked relative to the static roof section.

13. A retractable roof assembly for a vehicle the roof assembly having at least two lateral pairs of fore-and-aft spaced pillars, the vehicle having side windows that are disposed between a belt line of the vehicle and the roof and between fore-and-aft spaced pillars, the side windows being retractable below the belt line of the vehicle, the roof assembly comprising:
a plurality of relatively movable panels that extend laterally across the vehicle and are movable relative to each other in the fore-and-aft direction;
a pillar guide track disposed on the vehicle at the belt line on laterally spaced sides of the vehicle;
a follower being provided on each of the pillars of one of the lateral pair of pillars, the followers being received by the pillar guide tracks to guide movement of the lateral pair of pillars when the windows are retracted.

14. The retractable roof assembly of claim 13 wherein one of the relatively movable panels is assembled to the vehicle in a stationary position and at least one of the relatively movable panels is a slidable panel that is assembled to a track that permits the slidable panel to move in the fore-and-aft direction.

15. The retractable roof assembly of claim 13 wherein the pillar guide track is provided above the location where the windows are retracted into the vehicle.

16. The retractable roof assembly of claim 13 wherein the at least two pairs of pillars of the vehicle comprise a pair of A-pillars, a pair of B-pillars, a pair of C-pillars, and a pair of D-pillars, and wherein the pair of D-pillars is provided with the followers and the D-pillars are retracted to a position that is adjacent to the C-pillars.

17. The retractable roof assembly of claim 16 further comprising a retractable upper tailgate section that is disposed between the D-pillars in an extended position and is moved to a retracted position where it is vertically stacked relative to the relatively movable roof panels.
